(19) United States
(12) Patent Application Publication
(10) Pub. No.: US 2022/0072743 A1
(43) Pub. Date: Mar. 10, 2022

(54) THERMOPLASTIC COMPONENTS, SYSTEMS, AND METHODS FOR FORMING SAME

(71) Applicant: The Research Foundation for the State University of New York, Albany, NY (US)

(72) Inventors: Shenqiang Ren, Williamsville, NY (US); Lu aN, Buffalo, NY (US)

(21) Appl. No.: 17/360,660

(22) Filed: Jun. 28, 2021

Related U.S. Application Data
(60) Provisional application No. 63/044,600, filed on Jun. 26, 2020.

(51) Int. Cl. B29C 43/52; B29C 43/58; B29C 65/00; B29C 70/44

(52) U.S. Cl. CPC B29C 43/52; B29C 43/58; B29K 2101/12; B29C 70/44; B29C 66/7212

(57) ABSTRACT

Systems for forming thermoplastic components are disclosed. A system may include a mold including a first portion and a second portion engaging the first portion. The first portion and/or the second portion may receive material for the component. The system may also include a compressive device positioned adjacent to and contacting the first portion of the mold. Additionally, the system may include a control system in communication with the compressive device. The control system may be configured to displace the compressive device to apply a compressive force to the first portion of the mold, and impose a predetermined pressure on the material for the component. The control system may also be configured to heat the first portion and/or the second portion of the mold.

### CROSS-REFERENCE TO RELATED APPLICATIONS

This application claims priority to U.S. provisional application No. 63/004,600 filed on Jun. 26, 2020, the content of which is hereby incorporated by reference into the present application.

### GOVERNMENT RIGHTS

This invention was made with government support under Grant No. W911NF-18-2-0202 awarded by the US Army Research Office. The government has certain rights in the invention.

### BACKGROUND

The disclosure relates generally to thermoplastics, and more particularly, to thermoplastic components, as well as systems and methods for forming thermoplastic components.

Getting nature inspiration to develop functionally architectured materials provides an effective way to design the protecting material systems from external threats. In this context, the body armor materials have been designed for body protection by absorbing energy from deflecting the slashing, bludgeoning and penetrating attacks under the ballistic shock. These materials have progressed from the rudimentary leather to metal plating, and more recently to synthetic engineering polymeric materials. Despite the innovative lightweight armor materials capable of high toughness and extraordinary energy absorption, as well as tensile-strength-to-weight ratio, the sophisticated weaponry and complex environments has motivated the continuous improvement of light weight protective materials. One of the intriguing methods to achieve drastic shock mitigation and penetration is functionally graded materials (FGMs). The ability of the FGM offers the penetration and impact resistant properties, making it attractive for protection. The design of FGMs has been inspired by natural tissues, such as teeth, bone and nacre, etc. The gradient structure existed in nacre enables its high stiffness-to-weight ratio. Such functionally graded materials suggest that bio-inspired materials can be applied as high performance energy absorbing materials, which can be prepared by several techniques, such as the vapour deposition, powder metallurgy, centrifugal method, and solid freeform fabrication, etc.

For example, ultra-high molecular weight polyethylene (UHMWPE), linear homopolymer composed of monomeric ethylene units (—CH₂—CH₂—)ₙ— with an average molar mass of more than 3.1 million g/mol (i.e., n≈110,000 monomeric units), has shown a remarkable strength-to-weight ratio, and an excellent energy absorption ability. That is, UHMWPE exhibits lightweight, high thermal conductivity, and high strength (its specific strength is 14 time larger than that of steel). High impact strength of UHMWPE is desirable for structural applications, such as biomedical implants, personal or vehicle protection equipment. However, conventional manufacturing methods for creating parts or products from UHMWPE, or other similar thermoplastics results in less-than-required material characteristics—e.g., lower or limited impact strength. For example, parts or products formed from thermoplastic material are conventionally injection molded or compression molded using polyethylene powders, slurries, or the like. During these conventional formation processes, the material used to form the parts or products is typically uniformly heated and cooled. Products or parts may be molded in a final product configuration or may be created as bulk material and undergoing additional processing (e.g., material removal processes) to form the part/product. Regardless of the formation method, conventionally made thermoplastic products often limited in their application because of the material characteristics associated with the products or parts.

### BRIEF DESCRIPTION

A first aspect of the disclosure provides a system for forming a component. The system includes a mold including a first portion and a second portion engaging the first portion, at least one of the first portion or the second portion receiving material for the component; a compressive device positioned adjacent to and contacting the first portion of the mold; and a control system in communication with the compressive device, the control system configured to: displace the compressive device to: apply a compressive force to the first portion of the mold, and impose a predetermined pressure on the material for the component; and heat at least one of the first portion or the second portion of the mold.

A second aspect of the disclosure provides a component. The component includes: a body including: a first section including a first surface of the body, the first section having a first material characteristic; and a second section positioned opposite the first section, the second section including a second surface of the body, wherein the second section has a second material characteristic that is distinct from the first material characteristic of the first section.

A third aspect of the disclosure provides a method of forming a component. The method includes: depositing a material within a cavity of a mold, the cavity formed between a first portion of the mold and a second portion engaging the first portion; applying a pressure to the material deposited within the cavity of the mold; heating the material deposited within the cavity of the mold to a predetermined temperature for a predetermined period of time; and cooling the material deposited within the cavity of the mold to form the component.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows an exploded, isometric view of a system for forming a component, according to embodiments of the disclosure.

FIG. 2 shows a front cross-sectional view of the system of FIG. 1 taken along line CS-CS prior to heating a material, according to embodiments of the disclosure.

FIG. 3 shows a front cross-sectional view of the system of FIG. 1 taken along line CS-CS after heating a material, according to embodiments of the disclosure.

FIG. 4 shows an enlarged, cross-sectional side view of a component formed using the system of FIG. 1, according to embodiments of the disclosure.

FIG. 5 shows an isometric view of a component and a laser device, according to embodiments of the disclosure.

FIG. 6 shows an enlarged, cross-sectional side view of the component of FIG. 5 after undergoing a laser peening process, according to embodiments of the disclosure.

FIG. 7 shows a front cross-sectional view of the system of FIG. 1 taken along line CS-CS prior to heating a material and a plurality of fibers, according to embodiments of the disclosure.

FIG. 8 shows a front cross-sectional view of the system of FIG. 1 taken along line CS-CS after heating a material and the plurality of fibers, according to embodiments of the disclosure.

FIG. 9 shows an enlarged, cross-sectional side view of a component including a plurality of fibers, according to embodiments of the disclosure.

FIG. 10 shows a front cross-sectional view of the system of FIG. 1 taken along line CS-CS prior to heating a material and a plurality of fibers, according to additional embodiments of the disclosure.

FIG. 11 shows a front cross-sectional view of the system of FIG. 1 taken along line CS-CS after heating a material and the plurality of fibers, according to additional embodiments of the disclosure.

FIG. 12 shows a front cross-sectional view of the system of FIG. 1 taken along line CS-CS prior to heating a material and a plurality of fibers, according to further embodiments of the disclosure.

FIG. 13 shows a top schematic view of a plurality of fibers included in the system shown in FIG. 12, according to embodiments of the disclosure.

FIG. 14 shows a flowchart illustrating a process for forming a component, according to embodiments of the disclosure.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION

As an initial matter, in order to clearly describe the current disclosure, it will become necessary to select certain terminology when referring to and describing relevant components within the disclosure. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

As indicated above, the disclosure relates generally to thermoplastics, and more particularly, to thermoplastic components, as well as systems and methods for forming thermoplastic components.

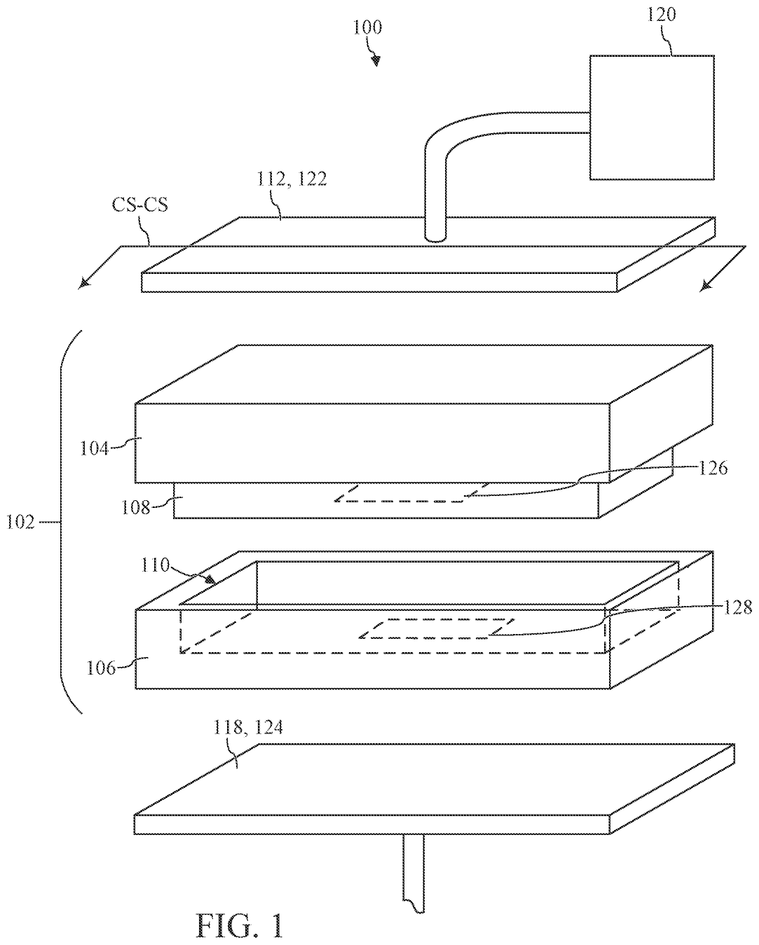

These and other embodiments are discussed below with reference to FIGS. 1-14. However, those skilled in the art will readily appreciate that the detailed description given herein with respect to these Figures is for explanatory purposes only and should not be construed as limiting.

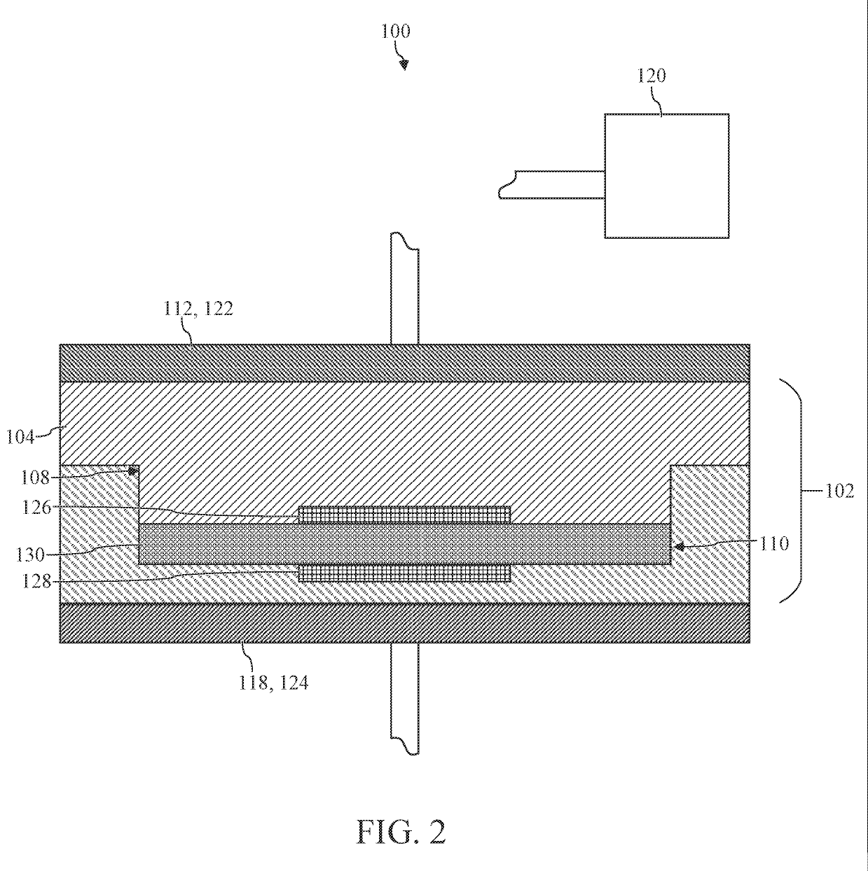

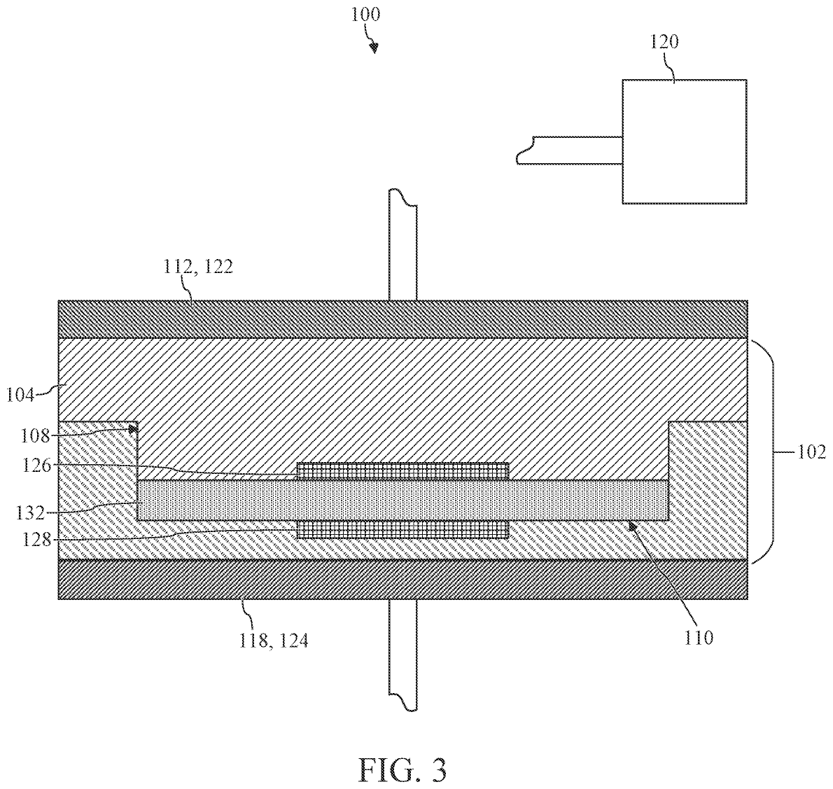

FIGS. 1-3 show a system 100 for forming a thermoplastic component (see, FIG. 3). More specifically, FIG. 1 shows exploded, isometric view of system 100, FIG. 2 shows a front cross-sectional view of system 100 taken along line CS-CS in FIG. 1 prior to heating material used to form a thermoplastic component, and FIG. 3 shows a front cross-sectional view of system 100 taken along line CS-CS in FIG. 1 after forming a thermoplastic component.

In the non-limiting example system 100 may include mold 102. As discussed herein, mold 102 may receive material (see, FIG. 2) that may be utilized in the formation of the thermoplastic component. Mold 102, and the various features included therein may define the configuration, geometry, and/or orientation of the thermoplastic component. That is, in the non-limiting example, the shape and/or configuration of thermoplastic component formed by system 100 may be determined, at least in part, by mold 102 forming the component. Mold 102 of system 100 may include a plurality of portions. In the non-limiting example shown in FIGS. 1-3, mold 102 may include a first portion 104 and a second portion 106 engaging first portion 104. First portion 104 may be positioned above and substantially aligned with second portion 106. In the non-limiting example, first portion 104 may include punch or extrusion 108 (hereafter, “punch 108”) extending from a surface positioned directly adjacent second portion 106. Second portion 106 may include a cavity or recess 110 (hereafter, “cavity 110”) formed into a surface of second portion 106 directly adjacent first portion 104 and/or punch 108. Cavity 110 may extend partially through and/or into second portion 106. In the non-limiting example, cavity 110 of second portion 106 may receive a material that may form thermoplastic component. As shown in FIGS. 1-3, punch 108 may be sized to be inserted within cavity 110 during the formation process of the thermoplastic component. However, punch 108 may not contact the surface of cavity 110 in second portion 106, but rather may leave a space or gap between the respective portions 104, 106 in which the component may be formed, as discussed herein. The shape and/or configuration of punch 108 of first portion 104 and cavity 110 of second portion 106 are non-limiting examples. As such, punch 108 and/or cavity 110 may be formed in any or configuration to form a desired geometry and/or shape for thermoplastic component.

Mold 102, and more specifically first portion 104 and second portion 106, respectively, may be formed from any substantially rigid material that may hold the material/powder to form the thermoplastic component. Furthermore, first portion 104 and second portion 106 of mold 102 may be formed from any suitable material that may withstand force and/or impart pressure on the material forming the thermoplastic during formation process discussed herein. Additionally, in the non-limiting examples, and as discussed herein, first portion 104 and second portion 106 of mold 102 must be formed from thermally conductive material to impart or transfer heat to the material positioned within cavity 110 during the formation process. In non-limiting examples, first portion 104 and second portion 106 of mold 102 may be formed from any suitable metals, metal alloys, and/or ceramics. Although two portions are shown in the figures in forming mold 102, it is understood that mold 102 may be formed from more portions and/or may include more features. As discussed herein, the number of features, number of portions, and/or the configuration of the portions may be based on the desired shape and/or configuration of the thermoplastic component formed by system 100.

System 100 may also include at least one compressive device 112. In the non-limiting example shown in FIGS. 1-3, compressive device 112 of system 100 may be positioned adjacent and above first portion 104 of mold 102. Additionally, compressive device 112 may contact first portion 104 of mold during the formation process. That is, compressive device 112 may impart a force on first portion 104 of mold 102 to apply and/or generate a pressure on the powder positioned within cavity 110 of second portion 106 during the component formation process. During operation, compressive device 112 may press first portion 104 into second portion 106, which in turn may position punch 108 within cavity 110. Compressive device 112 of system 100 may be formed as any suitable device, system, and/or component configured to impart a force on first portion 104, and in turn apply a pressure to the powder positioned within mold 102 that may be utilized to form thermoplastic component. In non-limiting examples, compressive device 112 may include any suitable hydraulic press, pneumatic press, mechanical press, or the like.

In the non-limiting example, system 100 may also include a support device 118. Support device 118 may be positioned adjacent to and below contact second portion 106 of mold 102. Additionally, support device 118 may be stationary, and may be configured to receive, hold, and/or support second portion 106. That is, second portion 106 may be positioned on, may be received by, and/or may be coupled to support device 118 of mold 102 during the component formation process discussed herein. During operation, support device 118 may hold, maintain, and/or support second portion 106 as first portion 104 engages, is pressed/forced into second portion 106, and/or provides pressure to the material positioned within cavity 110 of second portion 106. Support device 118 may be formed as any suitable device configured to support second portion 106 of mold 102 and/or withstand force/pressure applied by compressive device 112. In a non-limiting example, support device 118 may be a substantially rigid table or platform for supporting and holding second portion 106.

In other non-limiting example, support device 118 may be configured to move. That is, support device 118 may function and/or operation similar to compressive device 112, and may be configured to move, displace, and/or press second portion 106 of mold 102 into first portion 104. In the non-limiting example, first portion 104 and second portion 106 may be pressed together via compressive device 112 and support device 118, respectively. As a result, when first portion 104 and second portion 106 are pressed into one another, a pressure may be imparted on the powder positioned within cavity 110 of second portion 106 to form thermoplastic component.

System 100 may also include a control system 120. Control system 120 may be a stand-alone system, or alternatively may be a portion and/or included in a larger computing device (not shown) of system 100. As discussed herein, control system 120 may be configured to control system 100 to aid in the operation of system 100 and/or aid in the formation of the thermoplastic component. As shown in FIG. 1, control system 120 may be in electronic communication with and/or communicatively coupled to various devices, apparatuses, and/or portions of system 100. In non-limiting examples, control system 120 be hard-wired and/or wirelessly connected to and/or in communication with system 100, and its various components via any suitable electronic and/or mechanical communication component or technique. For example, control system 120 may be in electronic communication with compressive device 112. Control system 120 may be in communication with compressive device 112 to control the movement, actuation, and/or operation of compressive device 112 during the formation process discussed herein. That is, and as discussed herein, once powder is deposited into cavity 110 of second portion 106, control system 120 may instruct and/or operate compressive device 112 to apply a force to first portion 104, which in turn may impart or apply a constant pressure to the powder positioned within cavity 110. Additionally, and as discussed herein, control system 120 may also receive, process, and/or analyze inputs from various devices, portions, and/or sensors within system 100 to perform and/or optimize formation process of the thermoplastic component performed by system 100.

Control system 120 may also be in communication with support device 118. In the non-limiting example where support device 118 may also be configured to move, control system 120 may also be in communication with support device 118 to control the movement, actuation, and/or operation of support device 118 during the formation process discussed herein. That is, and as discussed herein, once powder is deposited into cavity 110 of second portion 106, control system 120 may instruct and/or operate support device 118 to apply a force to second portion 106, which in turn may impart or apply a constant pressure to the powder positioned within cavity 110. The force and/or actuation of second portion 106 may occur substantially simultaneous to the force being applied to first portion 104 by compressive device 112.

System 100 may also include at least one heating device 122, 124. In a non-limiting example, first heating device 122 may be formed integral with and/or may be formed as compressive device 112. That is, compressive device 112 may also form, act as, and/or be simultaneously configured as first heating device 122 of system 100. In the non-limiting example first heating device 122 may be in electronic communication with control system 120, such that control system 120 may control the operation of first heating device 122. In a non-limiting example, control system 120 may apply an energy, power, current, and/or output directly to first heating device 122/compressive device 112 in order to heat compressive device 112. During operation, first heating device 122 formed integral with and/or as compressive device 112 may heat mold 102, and more specifically first portion 104 of mold 102, to apply a heat to and/or increase the temperature of the powder deposited into cavity 110 of second portion 106 while also under pressure via first portion 104. In the non-limiting example where compressive device 112 is also integral formed as and/or integrally includes first heating device 122, compressive device 112 may be formed from a conductive material that may be heated and/or apply even heat to first portion 104 of mold 102. Formed as a conductive material compressive device 112/first heating device 122 may receive the applied/imparted energy, power, current, and/or output from control system 120, and may increase in temperature. As a result of the thermally conductive properties of first portion 104 of mold 102, the heat generated by compressive device 112/first heating device 122 may heat first portion 104, and in turn, increase the temperature of the material deposited in cavity 110 of second portion 106.

In a non-limiting example, second heating device 124 may be formed integral with and/or may be formed as support device 118. That is, support device 118 may also form, act as, and/or be simultaneously configured as second heating device 124 of system 100. In the non-limiting example, and similar to first heating device 122, second heating device 124 may be in electronic communication with control system 120, such that control system 120 may control the operation of second heating device 124. Control system 120 may apply an energy, power, current, and/or output directly to second heating device 124/support device 118 in order to heat support device 118. During operation, second heating device 124 formed integral with and/or as support device 118 may heat mold 102, and more specifically second portion 106 of mold 102, to apply a heat to and/or increase the temperature of the powder deposited into cavity 110 of second portion 106 while also under pressure via first portion 104. In the non-limiting example where support device 118 is also integral formed as and/or integrally includes second heating device 124, support device 118 may be formed from a conductive material that may be heated and/or apply even heat to second portion 106 of mold 102. Formed as a conductive material support device 118/second heating device 124 may receive the applied/imparted energy, power, current, and/or output from control system 120, and may increase in temperature. As a result of the thermally conductive properties of second portion 104 of mold 102, the heat generated by support device 118/second heating device 124 may heat second portion 106, and in turn, increase the temperature of the material deposited in cavity 110 of second portion 106.

System 100 may also include at least one sensor 126, 128 (shown in phantom in FIG. 1). Sensor(s) 126, 128 may be positioned within system 100 to monitor, determine, and/or detect the temperature of the powder deposited into cavity 110 of mold 102 during the formation process of thermoplastic component. In the non-limiting example shown in FIGS. 1-3, a first sensor 126 may be formed, positioned, embedded, and/or formed integral with first portion 104 of mold 102, adjacent cavity 110. More specifically, first sensor 126 may be formed integrally and/or embedded within punch 108 of first portion 104 and may be positioned substantially adjacent and/or exposed in a surface of punch 108 that may contact the powder deposited within cavity 110. Also as shown in the non-limiting example of FIGS. 1-3, system 100 may include a second sensor 128 formed adjacent cavity 110, in second portion 106 of mold 102. Second sensor 128 may be formed, positioned, embedded, and/or formed integral with second portion 106 of mold 102, adjacent cavity 110. More specifically, second sensor 128 may be formed integrally and/or embedded within cavity 110 of second portion 106 and may be positioned substantially adjacent and/or exposed in a surface of cavity 110 that may contact the powder deposited therein. Sensor(s) 126, 128 may be positioned substantially adjacent and/or exposed within cavity 110 to more accurately measure the temperature of the powder used to form thermoplastic component using system 100.

Control system 120 may be in electrical communication, mechanical communication, and/or electronically coupled with sensor(s) 126, 128 positioned within system 100. As discussed herein, sensor(s) 126, 128 in communication with control system 120 may be any suitable sensor or device configured to detect and/or determine data, information, and/or characteristics relating to the material deposited into cavity 110 during operation of system 100. For example, and as discussed herein, sensor(s) 126, 128 may be any suitable sensor configured to detect and/or determine a temperature of the material. In non-limiting examples, sensor(s) 126, 128 may be configured as, but not limited to, thermometers, thermistor, thermocouples, and/or any other mechanical/electrical temperature sensor. Although two sensors 126, 128 are shown, it is understood that system 100 may include more (or less) sensor(s) that may be configured to provide control system 120 with information or data relating to system 100 during operation (e.g., temperature of first portion 104 of mold 102, temperature of second portion 106 of mold 102, pressure within cavity 110, and the like). As such, the number of sensors 126, 128 shown in FIGS. 1-3 is illustrative and non-limiting.

Turning to FIGS. 2 and 3, and with continued reference to FIG. 1, methods of forming a thermoplastic component are disclosed herein. As discussed herein a material may be deposited within mold 102. In one non-limiting example, a granulated or powder material 130 used to form thermoplastic component may be deposited, disposed, and/or positioned within cavity 110 of second portion 106 for mold 102. Powder material 130 may be deposited within cavity 110 using any suitable process including, but not limited to, automated deposition using a deposition apparatus, or manually deposited therein. Powder material 130 may include a predetermined mass, volume, and/or amount based on build factor(s) and/or characteristic(s) of the thermoplastic component and/or system 100. Build characteristics may include, but are not limited to, the size, dimensions, density, and/or shape of the thermoplastic component to be formed using system 100. Additionally, or alternatively, build characteristics may include, but are not limited to, the size, dimension, volume, and/or shape of punch 108 and/or cavity 110, respectively, of mold 102. Powder material 130 may be formed from any suitable thermoplastic material including, but not limited to, polyethylene (PE), polypropylene, polyvinyl chloride (PVC), and/or any other suitable material that may be processed as discussed herein to form thermoplastic component.

In another non-limiting example (not shown), the material used to form thermoplastic component using system 100 may be formed as a plurality of preformed, thin sheets or blanks of material. That is, in place of powder material 130, system 100 may form the thermoplastic component using a plurality of preformed, thin (e.g., 5 to 15 mm thick) sheets of thermoplastic material. The thin sheets or blanks may be formed from similar thermoplastics as those discussed herein (e.g., polyethylene (PE), polypropylene, polyvinyl chloride (PVC), and so on). Additionally, the preformed sheets may be formed, prefabricated, or manufactured in bulk or in large quantities and/or at large lengths and then cut to a predetermined size in preparation for use within system 100 to form the thermoplastic component. In this non-limiting example, the plurality of thin sheets may be stacked (and trimmed to fit) within mold 102 of system 100. Once positioned within mold 102, the plurality of preformed, thin sheets of material may undergo similar processes (e.g., heating, cooling), and experience similar reactions or changes (e.g., melting, crystallization) as discussed herein with respect to powder material 130. The number of preformed, thin sheets used to form the thermoplastic component may be dependent upon the size or thickness of the formed component, and/or the thickness of each of the plurality of preformed, thin sheets of material.

Once powdered material 130 is deposited into mold 102, a pressure may be applied to the powder material 130. Pressure may be applied to powder material 130 using compressive device 112. For example, compressive device 112 may move and/or be actuated to press and/or position first portion 104 of mold 102 to contact section portion 106. More specifically, control system 120 may actuate or control compressive device 112 to compress first portion 104 of mold 102 and second portion 106 of mold 102, such that a portion of first portion 104 contacts second portion 106 directly, and punch 108 contacts and/or applies a pressure or force to powder material 130 deposited within cavity 110 of mold 102. In the non-limiting example where support device 118 is stationary or fixed, support device 118 may not move and may hold second portion 106 as first portion 104 is compressed there against. In another non-limiting example where support device 118 may be actuated and/or move similar to compressive device 112, support device 118 may be similarly actuated by control system 120 to compress second portion 106 into and/or against first portion 104 of mold 102. In either example, powder material 130 may be under a constant pressure within cavity 110.

Once compressed and/or under pressure, system 100 may heat powder material 130 deposited within cavity 110 of mold 102. More specifically, system 100 may heat powder material 130 to a predetermined temperature and/or for a predetermined time to alter the composition of powder material 130 (e.g., melt). Powder material 130 may be heated while remaining under pressure within mold 102. System 100 may utilize first heating device 122 and/or second heating device 124 to heat powder material 130. More specifically in non-limiting examples, first heating device 122, or alternatively first heating device 122 and second heating device 124 may be utilized to heat powder material 130 deposited within cavity 110. As shown in FIGS. 1-3, and as discussed herein, compressive device 112 may be formed as first heating device 122, and support device 118 may be formed as second heating device 124. Control system 120 may provide power, energy, and/or current to first heating device 122 (e.g., compressive device 112) and/or second heating device 124 (e.g., support device 118), which in turn may transfer the heat to mold 102 to heat powder material 130 deposited therein. Similar to the amount of deposited powder material 130, the predetermined temperature and predetermined period of time may be dependent upon, at least in part, build factor(s) and/or characteristic(s) of the powder material 130, thermoplastic component, and/or system 100. Build characteristics may include, but are not limited to, the size, dimensions, density, shape, and/or material composition of the powder material 130/thermoplastic component. Additionally, or alternatively, build characteristics may include, but are not limited to, the size, dimension, volume, and/or shape of first portion 104, second portion 106, punch 108 and/or cavity 110, respectively, of mold 102.

In a non-limiting example, powder material 130 may be heated via first heating device 122. That is, first heating device 122, formed as compressive device 112 as well, may be heated, and provide heat to first portion 104 of mold 102. In turn, heating the powder material 130 may include heating first portion 104 of mold 102, via first heating device 122, to a (first) predetermined temperature for a (first) predetermined period of time. The predetermined temperature and predetermined period of time may ensure powder material 130 may be melted, transform, and/or be processed to form thermoplastic component 132, as shown in FIG. 3. That is, in a non-limiting example where first heating device 122 is only used, powder material 130 heated to the predetermined temperature and for the predetermined period of time may be transformed to form solid, thermoplastic component 132 (see, FIG. 3).

In another non-limiting example, second heating device 124 may only be used to heat powder material 130. Similar to first heating device 122, second heating device formed as support device 118 may be heated and provide heat to second portion 106 of mold 102. In turn, heating the powder material 130 may include heating second portion 106 of mold 102, via second heating device 124, to the predetermined temperature for the predetermined period of time. The predetermined temperature and predetermined period of time may ensure powder material 130 may be melted, transform, and/or be processed to form thermoplastic component 132. That is, in a non-limiting example, where second heating device 124 is only used, powder material 130 heated to the predetermined temperature and for the predetermined period of time may be transformed to form solid, thermoplastic component 132.

In a further non-limiting example, both first heating device 122 and second heating device 124 may be used to heat powder material 130. That is, first heating device 122 (e.g., compressive device 112) and second heating device 124 (e.g., support device 118) may be heated, and provide heat to first portion 104 and second portion 106, respectively, of mold 102. In the non-limiting example, heating powder material 130 may include heating first portion 104 of mold 102, via first heating device 122, to a first predetermined temperature for a first predetermined period of time. Additionally, and simultaneously, heating powder material 130 may include heating second portion 106 of mold 102, via second heating device 124, to a second predetermined temperature for a second predetermined period of time. In some examples of performing the process discussed herein, the first predetermined temperature and/or the first predetermined period of time may be the same as the second predetermined temperature and/or the second predetermined period of time. In other examples of performing the processes discussed herein, the first predetermined temperature and/or the first predetermined period of time may be distinct from the second predetermined temperature and/or the second predetermined period of time, respectively. In any example, the first and second predetermined temperatures, as well as the first and second predetermined period of times, may ensure powder material 130 may be melted, transform, and/or be processed to form thermoplastic component 132 within mold 102.

In one specific example, the first predetermined temperature for the first heating device 122 may be greater than the second predetermined temperature for the second heating device 124. Additional in the example, the first predetermined period of time for operation of first heating device 122 may be greater than the second predetermined period of time for the operation of second heating device 124. In turn, first portion 104 of mold 102 may be heated to a temperature higher than and for a longer period of time than second portion 106 of mold. This may also result in a portion of powder material 130 that may contact and/or be positioned within cavity 110 directly adjacent first portion 104 to be heated to a higher temperature and for longer than a distinct portion of powder material 130 that may contact and/or be positioned within cavity 110 directly adjacent second portion 106.

Once heated to the predetermined temperature for the predetermined period of time, powder material 130 deposited within cavity 110 of mold 102 may be cooled. More specifically, once powder material 130 is heated to the predetermined temperature for the predetermined period of time via heating device(s) 122, 124, the heat may be discontinued or turned off, and powder material 130 may undergo a cooling process. In one non-limiting example, powder material 130 may cool naturally (e.g., no external cooling devices or influences) within mold 102. Powder material 130 may cool within mold 102 while still under pressure (e.g., compressive device 112 compressing first portion 104 and second portion 106), or alternatively may be removed from system 100 and cooled outside of the pressure/compression supplied by compressive device 112 and/or support device 118. In another non-limiting example, additional devices, apparatuses, and/or external cooling processes may be used to cool powder material 130. For example, mold 102, including powder material 130 may undergo external or auxiliary cooling processes, such as cooling baths, refrigeration, and/or the like to cool or reduce the temperature of powder material 130. In further non-limiting examples, heated powder material 130, which may be at least partially solidified, may be removed from mold 102 to cool outside of system 100.

In any example discussed herein, the heating and subsequent cooling of powder material 130 may transform powder material 130 into thermoplastic component 132. That is, the process of heating powder material 130 (under constant pressure) and subsequently cooling powder material 130 may result in the formation of solid, thermoplastic component 132. Turning to FIG. 3, solid, thermoplastic component 132 formed in mold 102 may take the shape of cavity 110 defined by first portion 104 and second portion 106, as discussed herein. Additionally, and in response to heating and subsequently cooling powder material 130 deposited within cavity 110 of mold 102, a crystallization gradient may be formed within thermoplastic component 132. That is, as a result of heating powder material 130 with first heating device 122, second heating device 124, or both first heating device 122 and second heating device 124 (where first heating device is heated to a higher temperature for a longer time), a crystallization gradient may be formed within and/or throughout thermoplastic component 132. In the non-limiting example, and as discussed herein in detail, thermoplastic component 132 formed via the processes discussed herein with respect to FIGS. 1-3 may include a first section having a first crystallinity, and a second section formed adjacent the first section that has a second crystallinity that is distinct (e.g., lower) than the first crystallinity of the first section.

Thermoplastic component 132 may be formed from any suitable thermoplastic material that may undergo the processes and material/mechanical changes as discussed herein. In one non-limiting example, thermoplastic component 132 may be formed as an ultrahigh molecular weight polyethylene (UHMWPE) component. In other non-limiting examples, thermoplastic component 132 may be formed as a polypropylene component and/or a polyvinyl chloride (PVC) component.

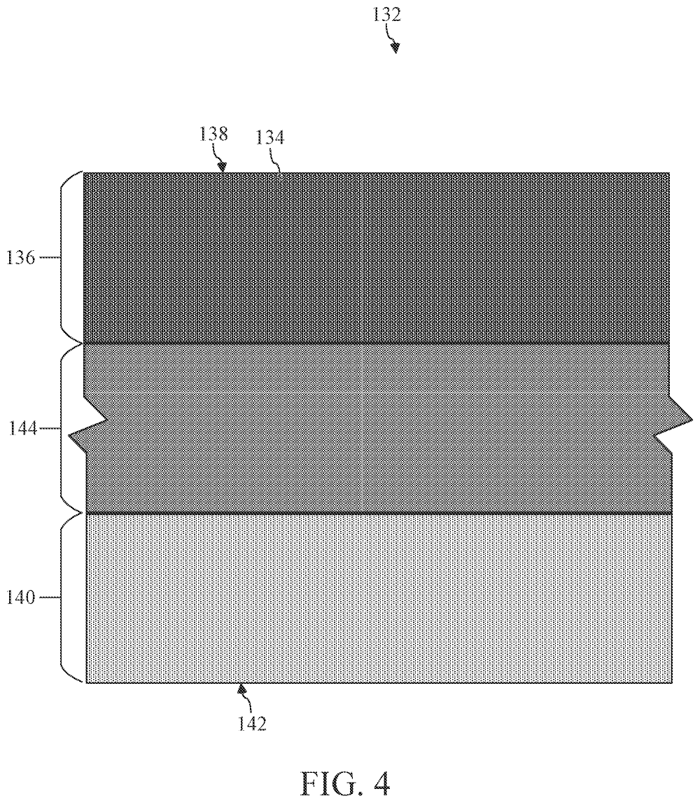

Turning to FIG. 4, shows an enlarged, cross-sectional side view of thermoplastic component 132 formed using system 100 shown in FIGS. 1-3. thermoplastic component 132 shown in FIG. 4 may be similar to that shown in FIG. 3. It is understood that similarly numbered and/or named components may function in a substantially similar fashion. Redundant explanation of these components has been omitted for clarity.

As discussed herein, and because of the formation processes discussed herein, solid thermoplastic component 132 may include distinct sections that have distinct material characteristics and/or properties (e.g., crystallization). As shown in FIG. 4, thermoplastic component 132 may include a single, unitary body 134 that may be formed from the melting, transforming, and/or bonding of powder material 130, as discussed herein. Additionally, as shown in FIG. 4, body 134 of thermoplastic component 132 may include various sections. The sections depicted in FIG. 4 and discussed herein are all integrally formed and/or make up unitary body 134. As such, it is understood that the distinctions in sections (e.g., identifying lines and borders) are provided for illustration. In a non-limiting example, unitary body 134 of thermoplastic component 132 may include a first section 136. First section 136 may include a first (e.g., top) surface 138 of body 134. First section 136 may correspond to the powder material 130 and/or a section of thermoplastic component 132 that may contact and/or be positioned directly adjacent first portion 104 of mold 102 for system 100. That is, and in the examples where first heating device 122 (e.g., compressive device 112) is only used, or alternatively where both first heating device 122 and second heating device 124 (e.g., support device 118) are used to form thermoplastic component 132, first section 136 may be positioned directly adjacent and/or contact first portion 104 of mold 102. Additionally, first surface 138 may directly contact first portion 104 of mold 102. As discussed herein, first section 136 may include a first material characteristic(s) or property.

In the non-limiting example shown in FIG. 4, unitary body 134 of thermoplastic component 132 may also include a second section 140, distinct from first section 136. Second section 140 may include a second (e.g., bottom) surface 142 of body 134 formed opposite first surface 138. Second section 140 may correspond to the powder material 130 and/or a section of thermoplastic component 132 that may contact and/or be positioned directly adjacent second portion 106 of mold 102 for system 100. That is, and in the examples where first heating device 122 (e.g., compressive device 112) is only used, or alternatively where both first heating device 122 and second heating device 124 (e.g., support device 118) are used to form thermoplastic component 132, second section 140 may be positioned directly adjacent and/or contact second portion 106 of mold 102. Additionally, second surface 142 may directly contact second portion 106 of mold 102. As discussed herein, second section 140 may include a second material characteristic(s) or property.

The first material characteristic(s) of first section 136 may be distinct from the second material characteristic(s) of second section 140. That is, the distinct sections 136, 140 of unitary body 134 for thermoplastic component 132 may include distinct material characteristic(s) as a result of the formation process discussed herein. The material characteristic(s) or properties for each of the sections of thermoplastic component 132 may include, but are not limited to, a crystallinity of the sections 136, 140, a tensile strength of the sections 136, 140, a hardness of the sections 136, 140, an impact strength of the sections 136, 140, a ductility of the sections 136, 140, and any other suitable material/mechanical property of the component. In a non-limiting example where the material characteristic includes the crystallinity of each section, the crystallinity of first section 136 may be greater than the crystallinity of second section 140. That is, and as a result of performing the formation process discussed herein, the crystallinity of first section 136 may be greater or higher than the crystallinity of second section 140. In one example, the crystallinity of first section 136 is within a range of approximately 70% to approximately 80%, and the crystallinity of second section 140 is within a range of approximately 50% to approximately 65%. In other non-limiting examples, and similar to the crystallinity, the material characteristics of first section 136 may be higher or greater than the material characteristics of second section 140. Specifically, the tensile strength, the hardness, the impact strength, and/or the ductility of first section 136 is greater the same material characteristic for second section 140.

The non-limiting example of thermoplastic component 132 shown in FIG. 4 may also include a third section 144, distinct from both first section 136 and second section 140. Third section 144 may positioned within thermoplastic component 132 substantially between first section 136 and second section 140. Third section 144 may correspond to the powder material 130 and/or a section of thermoplastic component 132 that may be positioned between first portion 104 and second portion 106 of mold 102 for system 100. Third section 144 may include a third material characteristic(s) or property that be distinct from the first material characteristic(s) of first section 136 and the second material characteristic(s) of second section 140. In a non-limiting example, the third material characteristic(s) for third section 144 may be higher or greater than the material characteristics of second section 140 but may be lower than the material characteristics of first section 136.

The three sections 136, 140, 144 of unitary body 134 for thermoplastic component 132 may be illustrative of the gradient formed in thermoplastic component 132 by system 100. As such, thermoplastic component 132 may not include specific, divided sections but may have an identifiable gradient or change in material characteristics between first surface 138 and second surface 142. Additionally, although shown as equal sizes, the gradient and/or change in material characteristics may vary in size and/or dept between first surface 138 and second surface 142 of thermoplastic component 132. The depth and/or configuration of the gradient may be dependent on build characteristics and/or process characteristics (e.g., predetermined temperature, predetermined period of time), as similarly discussed herein with respect to FIGS. 1-3.

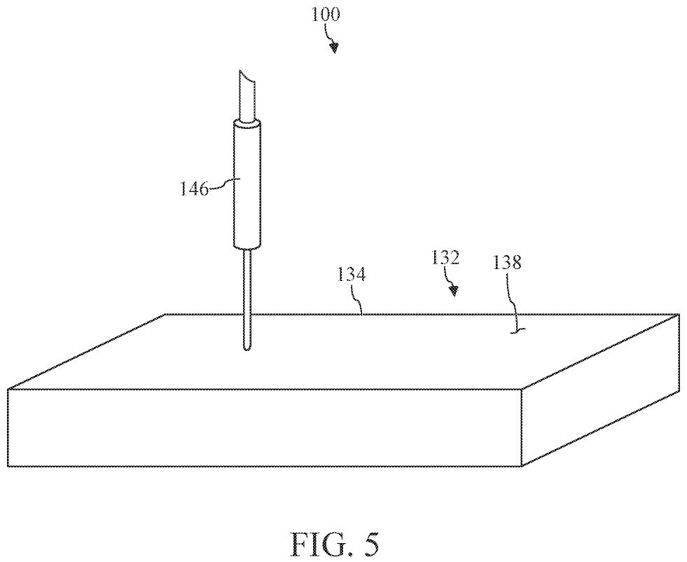

In another non-limiting shown in FIG. 5, system 100 may include additional features or apparatuses for forming thermoplastic component 132. FIG. 5 depicts a laser system or apparatus 146 (hereafter, “laser 146”) that may perform additional processes to form thermoplastic component 132. For example, laser 146 may be confirmed to provide a pulsed energy beam on thermoplastic component 132. More specifically, after thermoplastic component 132 is cooled and removed from mold 102, laser 146 may provide a pulsed energy beam on and/or over the entirety of first surface 138 of thermoplastic component 132. Laser 146 may provide the pulsed energy beam to perform a laser peening process on first surface 138 of thermoplastic component 132. As discussed herein, the laser peening process performed on thermoplastic component 132 by laser 146 may modify and/or alter thermoplastic component 132 to improve material characteristics (e.g., tensile strength, hardness). Laser 146 may be formed as any suitable laser system, device, and/or apparatus that may perform a laser peening process of thermoplastic component 132 using system 100.

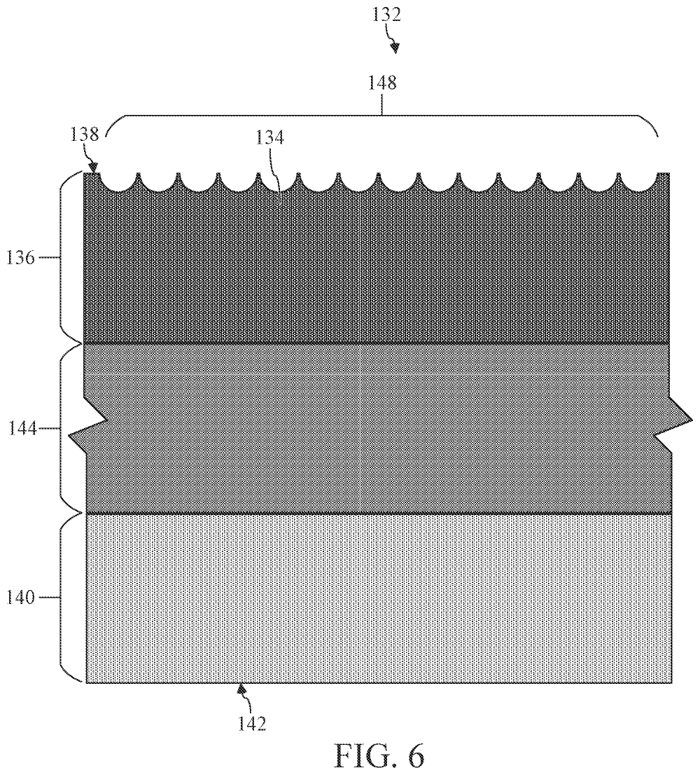

Turning to FIG. 6, shows an enlarged, cross-sectional side view of thermoplastic component 132 formed using system 100 shown in FIGS. 1-3, and subsequently laser peened using laser 146 of FIG. 5. It is understood that similarly numbered and/or named components may function in a substantially similar fashion. Redundant explanation of these components has been omitted for clarity.

As shown in FIG. 6, first surface 138 of unitary body 134 may include distinct features from those formed only using mold 102 of system 100 (see, FIG. 4). For example, performing the laser peening process on thermoplastic component 132 using laser 146 may result in the formation of dimples or a scalloped pattern 148 on first surface 138 of thermoplastic component 132. That is, scalloped pattern 148 may be formed in first surface 138 by laser peening first surface 138 using laser 146. The depth of each scallop or dimple formed in first surface 138 may only extend at least partially through and/or into first section 136. In other non-limiting examples, the scallop or dimple of scalloped pattern 148 may extend into unitary body 134 by a predetermined depth or impact dimension. The dept and/or size for each of the scallops or dimples of scalloped pattern 148 may be determined by, at least in part, a predetermined time of exposure to the laser beam, a predetermined intensity of the laser beam, build characteristics of thermoplastic component 132, and the like. In one non-limiting example, the height or depth of each scallop for scalloped pattern 148 formed in first surface 138 of thermoplastic component 132 may be within a range of approximately 1 millimeter (mm) to approximately 15 mm, where the thickness of thermoplastic component 132 is at least 16 mm. As discussed herein, laser peening first surface 138 may increase and/or improve the tensile strength and/or hardness of first surface 138/first section 136/unitary body 134 forming thermoplastic component 132.

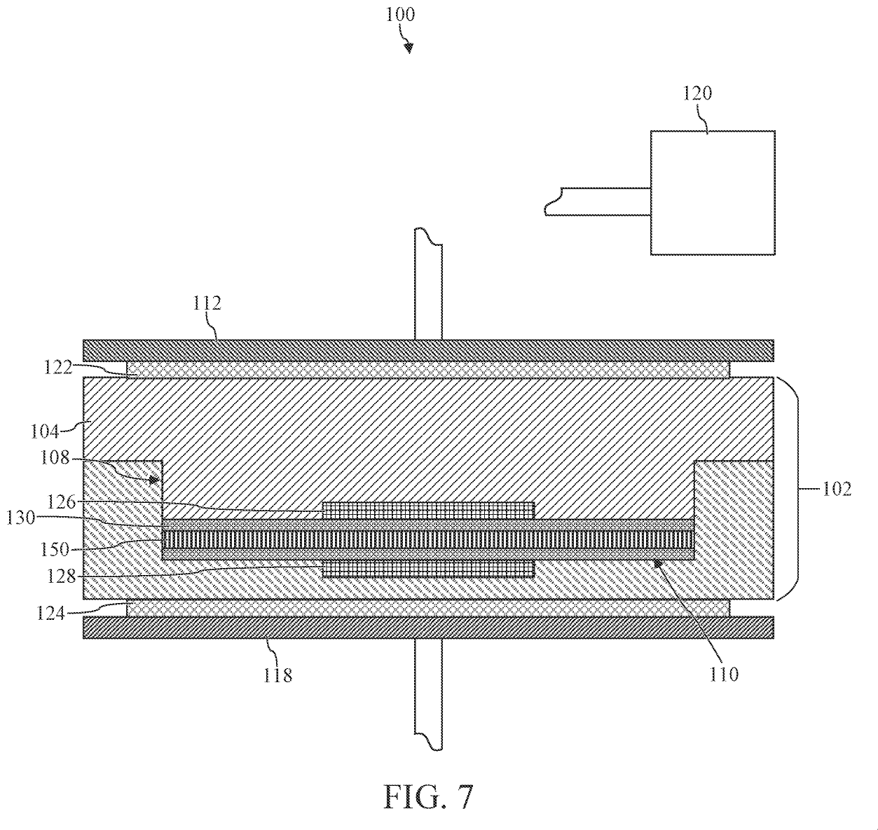

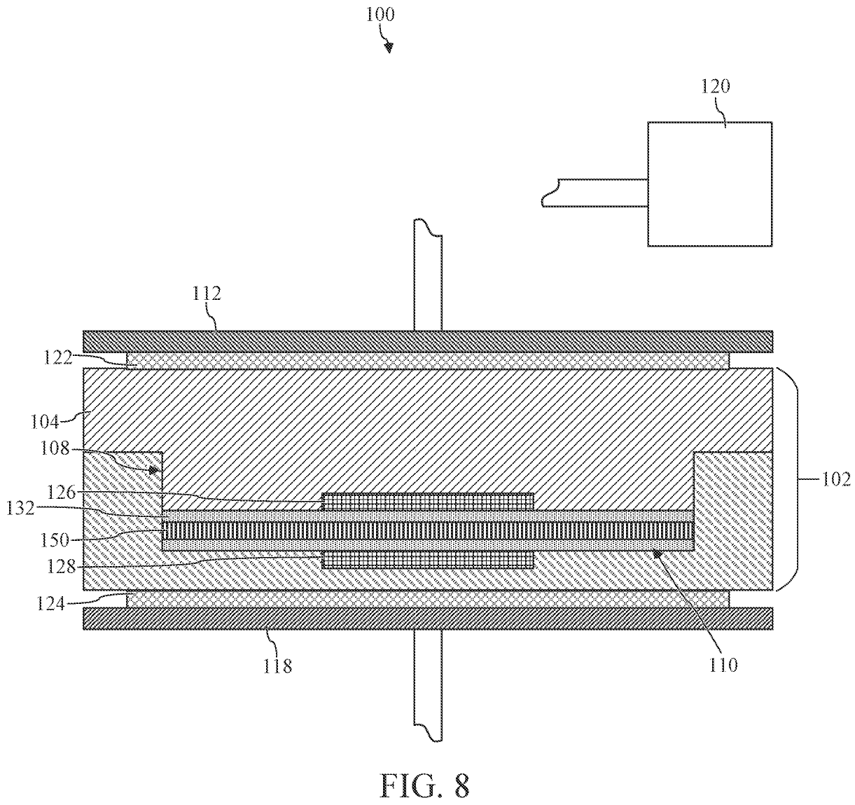

FIGS. 7 and 8 show another non-limiting example of system 100 include some similar and some distinct features, device, and configurations. It is understood that similarly numbered and/or named components may function in a substantially similar fashion. Redundant explanation of these components has been omitted for clarity.

As shown in FIGS. 7 and 8, first heating device 122 may be distinct from and positioned between compressive device 112 and first portion 104 of mold 102. That is, and with comparison to system 100 discussed herein with respect to FIGS. 1-3, first heating device 122 may not be integral formed with and/or also formed as compressive device 112, but rather first heating device 122 may be distinct and a stand-alone device from compressive device 112. In the non-limiting example, first heating device 122 may be electronically connected and/or in electronic communication with control system 120, such that control system 120 may control the operation and/or function of first heating device 122 during the formation of thermoplastic component 132.

Similar to first heating device 122, second heating device 124 may also be a distinct device. That is, second heating device 124 of system 100 shown in FIGS. 7 and 8 may be distinct from and positioned between support device 118 and second portion 106 of mold 102. In the non-limiting example, second heating device 124 may be electronically connected and/or in electronic communication with control system 120, such that control system 120 may control the operation and/or function of second heating device 124 during the formation of thermoplastic component 132.

As shown in FIGS. 7 and 8, first heating device 122 and second heating device 124 may contact first portion 104 and second portion 106, respectively. As such, and as similarly discussed herein, the heating devices 122, 124 may transfer heat the respective portions 104, 106 of mold 102 to heat powder material 130 deposited within cavity 110. First heating device 122 and second heating device 124 may be formed as any suitable device and from any suitable material that may withstand the compressive force imparted by system 100 during the formation process. Additionally, first heating device 122 and second heating device 124 may be formed from any suitable thermally conductive material to transfer heat to the portions 104, 106 of mold 102 during the process discussed herein.

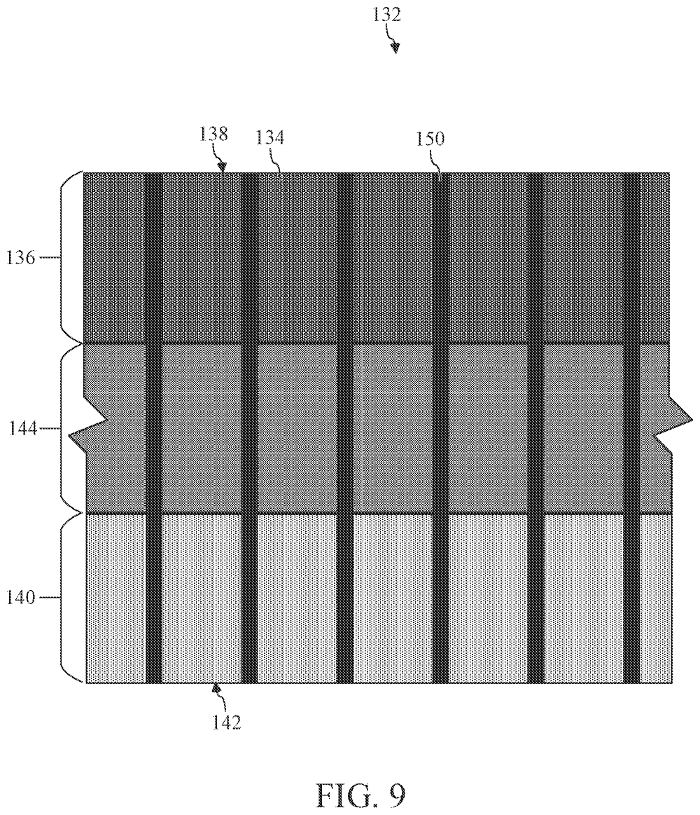

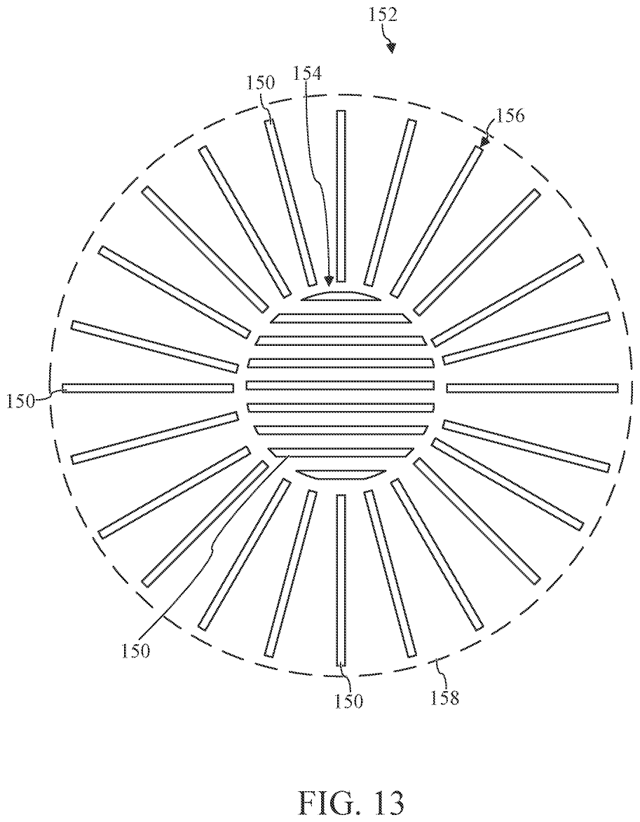

Additionally, as shown in FIGS. 7 and 8, a plurality of fibers 150 may be included within cavity 110 (see, FIG. 7) and in turn thermoplastic component 132 (see, FIG. 8). More specifically, a plurality or layer of fibers 150 may be deposited within cavity 110 of mold, along with the powder material 130, during the formation process. The plurality of fibers 150 may be formed as, in, or on a single supportive/laminated sheet (not shown) or may be layered individually within powder material 130. In the non-limiting, the plurality of fibers 150 may also be arranged in a plurality of rows (see, FIG. 13), formed by individual supportive/laminated sheets, which may be arranged in a predetermined configuration or geometry dependent, at least in part, on the build characteristics of thermoplastic component 132 and/or mold 102 of system 100. In the non-limiting example shown in FIGS. 7 and 8 where thermoplastic component 132 is formed as substantially cubic preform, the plurality of fibers 150 may be arranged in a plurality of parallel rows. In the non-limiting example shown in FIGS. 7 and 8, each of the plurality of fibers 150 may be oriented and/or positioned vertically. That is, and briefly turning to FIG. 9, each of the plurality of fibers may be positioned and/or oriented such that they are substantially perpendicular to the contact surface of punch 108 for first portion 104 and cavity 110 of second portion 106, respectively. Additionally, and as discussed herein, the vertically oriented fibers 150 may be substantially perpendicular to first surface 138 and second surface 142 of unitary body 134 forming thermoplastic component 132.

During the formation process, the plurality of fibers 150 may be deposited or positioned within cavity 110 of mold prior to powder material 130 may being deposited. Alternatively, a portion of powder material 130 may be deposited within cavity 110, followed by the plurality fibers 150, and subsequently the remainder of powder material 130, prior to applying pressure to and heating powder material 130 and the plurality of fibers 150. In one non-limiting example, powder material 130 may penetrate spaces formed between each fiber of the plurality fibers 150 prior to heating powder material 130 and the plurality of fibers 150. In another non-limiting example, the melting of powder material 130 may cause the material to penetrate the areas between each of the plurality of fibers 150.

Turning to FIG. 9, thermoplastic component 132 including the plurality of fibers 150 is shown. As discussed herein, the formation process of thermoplastic component 132 may result in the powder material 130 solidifying around and/or penetrating the spaces formed between each of the plurality of fibers 150. In the non-limiting example, each fiber 150 shown may represent one fiber of a plurality of fibers arranged in parallel rows (e.g., fibers extending in and out of the page—one behind/in front of the other) extending through thermoplastic component 132. As shown, each of the plurality of fibers may extend through at least a portion of first section 136, second section 140, and third section 144 of unitary body 134 forming thermoplastic component 132. Additionally, each of the plurality of fibers 150 may extend substantially perpendicular to and may extend from first surface 138 to second surface 142. In other non-limiting examples (not shown), the plurality of fibers 150 may be smaller than the predetermined thickness of thermoplastic component 132. In this non-limiting example, each of the plurality of fibers 150 may extend substantially perpendicular to and may extend between (but not to) at least one of first surface 138 to second surface 142 of unitary body 134.

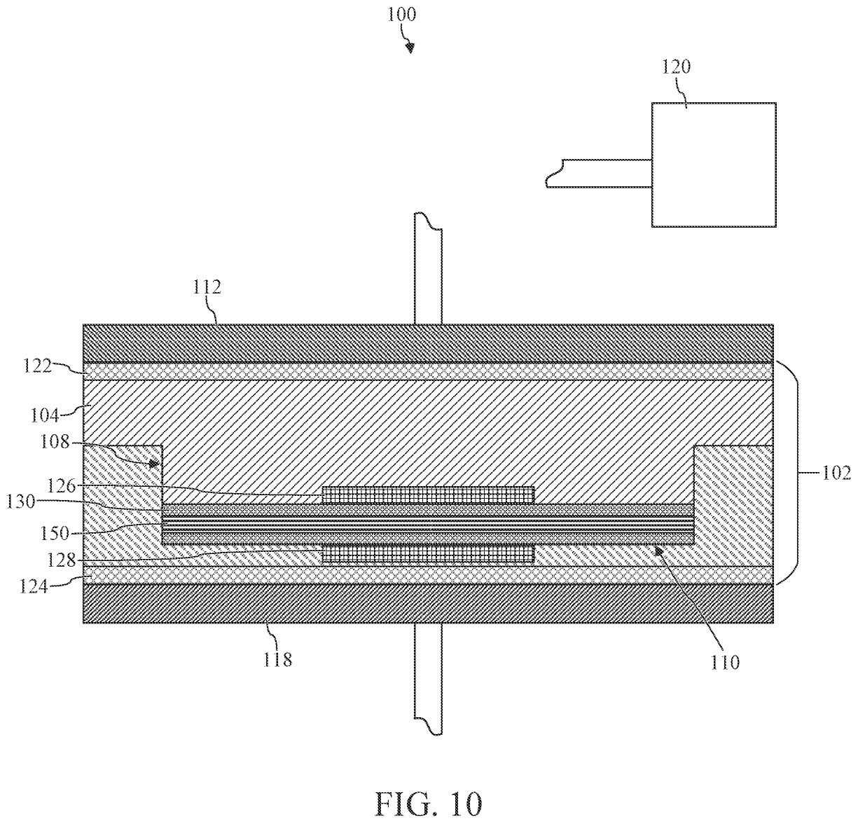

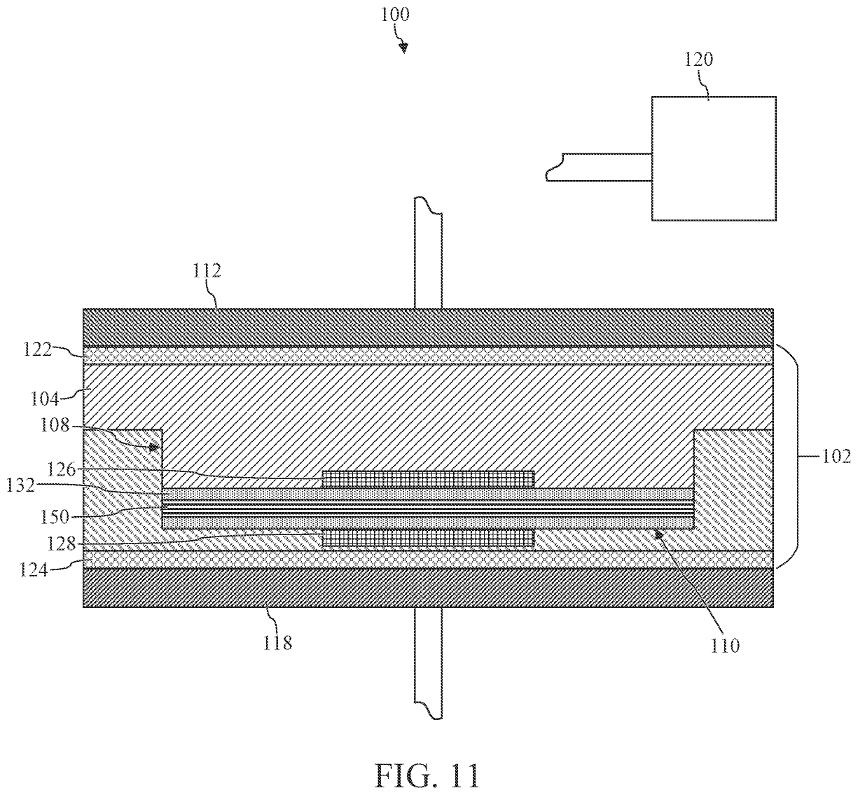

FIGS. 10 and 11 show another non-limiting example of system 100 include some similar and some distinct features, device, and configurations. As shown in FIGS. 10 and 11, first heating device 122 may be formed integral with first portion 104 of mold 102. That is, first heating device 122 may be integrally formed with and/or included within first portion 104 of mold 102. In the non-limiting example, first heating device 122 may be electronically connected and/or in electronic communication with control system 120, such that control system 120 may control the operation and/or function of first heating device 122 during the formation of thermoplastic component 132.

Similar to first heating device 122, second heating device 124 may also be a distinct device formed integrally within second portion 106. That is, second heating device 124 may be integrally formed with and/or included within second portion 106 of mold 102. In the non-limiting example, second heating device 124 may be electronically connected and/or in electronic communication with control system 120, such that control system 120 may control the operation and/or function of second heating device 124 during the formation of thermoplastic component 132.

Similar to FIGS. 7-9, a plurality of fibers 150 are shown in system 100 depicted in FIGS. 10 and 11. However, distinct from FIGS. 7-9, the plurality of fibers 150 in FIGS. 10 and 11 are positioned and/or oriented horizontally. That is, the plurality of fibers 150 shown in FIGS. 10 and 11 are not oriented perpendicular to first surface 138 and second surface 142 of thermoplastic component 132 (see, FIG. 9), but rather are positioned and/or oriented parallel to first surface 138 and second surface 142 of thermoplastic component 132 (see, FIG. 11). In the non-limiting example, parallel rows of a plurality of fibers 150 may extend within cavity 110 of mold from side-to-side within cavity 110, and may be substantially parallel to first surface 138 and second surface 142 of thermoplastic component 132, and/or a surface of punch 108/surface of cavity 110 of mold 102.

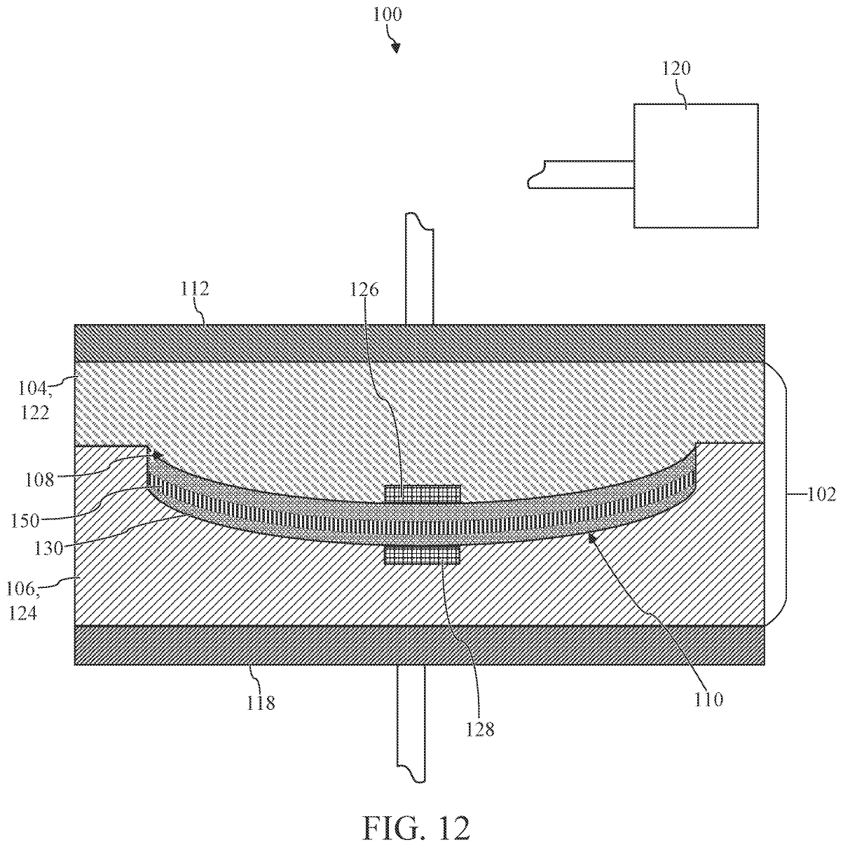

FIG. 12 shows another non-limiting example of system 100 used to form thermoplastic component 132. In the non-limiting example, first heating device 122 may be formed integrally as first portion 104 of mold 102, and second heating device 124 may be formed integrally as second portion 106 of mold 102. Similar to compressive device 112 shown and discussed herein with respect to FIGS. 1-3, first portion 104 of mold 102 may also form, act as, and/or be simultaneously configured as first heating device 122 of system 100. In the non-limiting example first heating device 122 may be in electronic communication with control system 120, such that control system 120 may control the operation of first heating device 122. In a non-limiting example, control system 120 may apply an energy, power, current, and/or output directly to first heating device 122/first portion 104 of mold 102 in order to heat first portion 104 and powder material 130, respectively.

Additionally, and similar to support device 118 shown and discussed herein with respect to FIGS. 1-3, second portion 106 of mold 102 may also form, act as, and/or be simultaneously configured as second heating device 124 of system 100. In the non-limiting example second heating device 124 may be in electronic communication with control system 120, such that control system 120 may control the operation of second heating device 124. In a non-limiting example, control system 120 may apply an energy, power, current, and/or output directly to first heating device 122/second portion 106 of mold 102 in order to heat second portion 106 and powder material 130, respectively.

In the non-limiting example where first portion 104 and second portion 106 are also integral formed as and/or integrally includes first heating device 122 and second heating device 124, respectively, first portion 104 and second portion 106 may be formed from conductive materials that may be heated and/or apply even heat to powder material 130 included in cavity 110 of mold 102.

As discussed herein, mold 102 may determine the shape, or configuration of thermoplastic component 132 formed using system 100. In the non-limiting example shown in FIG. 12, thermoplastic component 132 may substantially curved due to the shape and/or configuration of cavity 110 of mold 102. More specifically, punch 108 of first portion 104 and cavity 110 of second portion 106 may include corresponding curvatures and/or a substantially curved area or space that may receive powder material 130 and the plurality of fibers 150. In the non-limiting example, thermoplastic component 132 may include a first surface that is substantially concave, and a second surface positioned opposite the first surface that is substantially convex.

In the non-limiting example shown in FIG. 12, geometry, shape, and/or configuration of mold 102 and/or thermoplastic component 132 may also determine the configuration of the plurality of fibers 150 that may be included within thermoplastic component 132. That is, the plurality of fibers 150, and more specifically the rows of “vertically” oriented fibers 150, included in thermoplastic component 132 may be formed, positioned, and/or arranged in a predetermined pattern that may be dependent on, at least in part, the shape or configuration of thermoplastic component 132. The predetermined pattern for the plurality of fibers may ensure even spacing or distribution of the plurality of fibers 150 within thermoplastic component 132 during formation.

Turning to FIG. 13, and continuing the example from FIG. 12, a non-limiting example of a predetermined pattern 152 for the plurality of fibers 150 is shown. Each of the blocks of fibers 150 depicted in FIG. 13 may represent distinct pluralities of fibers that may be “vertical” and/or may extend or be oriented in and out of the page. As shown in FIG. 13, the predetermined pattern 152 of the plurality of fibers 150 may include a first or (a first group of) row of fibers that extend (or will extend) within unitary body 134 of thermoplastic component 132 at a first orientation, and a second (or a second group of) row of fibers that extend (or will extend) within unitary body 134 of thermoplastic component 132 at a second orientation, distinct from the first orientation. For example, predetermined pattern 152 of the plurality of fibers 150 may include a central group 154 of rows of fibers 150 that are parallel to one another, and oriented in a first direction (e.g., left to right). Additionally, predetermined pattern 152 may include an outer group 156 of rows of fibers 150 that circumferentially disposed around and/or surround the rows of fibers 150 forming central group 154. Each of the rows of fibers 150 forming outer group 156 may be oriented in a second (or more) direction, such that each rows of fibers in the circumferential configuration are evenly spaced from one another. The predetermined pattern shown in FIG. 13 may be unique and/or correspond to the curvature of thermoplastic component 132, as defined by cavity 110 of mold 102. That is, the central group 154 may correspond, align with, and/or be formed within a central portion of thermoplastic component 132 that may substantially planar and/or may include less curvature (see, FIG. 12). Conversely, outer group 156 may correspond, align with, and/or be formed within portions of thermoplastic component 132 that may be substantially curved (see, FIG. 12), and/or the portion which curves from the (planar) central portion to the outer edge of thermoplastic component 132. As thermoplastic component 132 is formed, the orientation of the various groups 154, 156 of the plurality of fibers 150 may ensure that the plurality of rows of fibers 150 are spaced evenly and/or maintain a perpendicular orientation to first surface 138 and second surface 142, as discussed herein.

The plurality of rows of fibers 150 shown in FIG. 13 may be disposed or positioned on a sacrificial sheet or support 158 (shown in phantom) that may be positioned within cavity 110 during the formation of thermoplastic component 132. Sacrificial sheet 158 may aid in the positioning of the plurality of rows of fibers 150 in predetermined pattern 152 prior to positioning or depositing the plurality fibers 150 in cavity 110 of mold 102. Sacrificial sheet 158 may disintegrate and/or melt into thermoplastic component 132 during the formation process and have minimal to no effect on the material composition or material characteristics of thermoplastic component 132 formed using system 100.

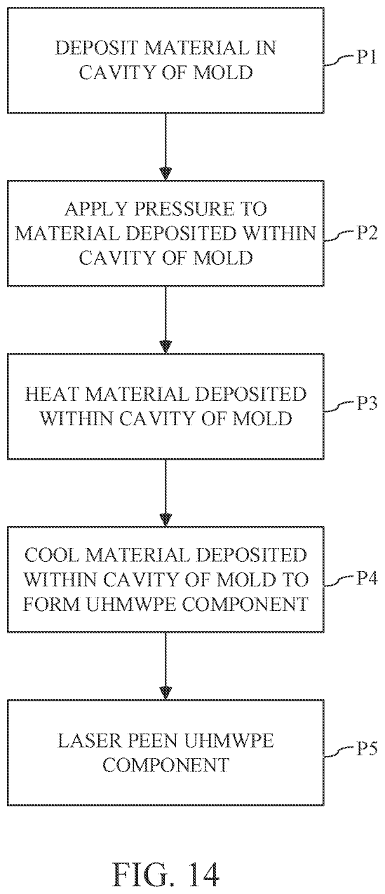

FIG. 14 depicts example processes for forming thermoplastic component. Specifically, FIG. 14 is a flowchart depicting one example process for forming a thermoplastic component that includes a mechanical-characteristic gradient within the single body of the component. In some cases, a system may be used to form the thermoplastic component, as discussed above with respect to FIGS. 1-3, 7, 8, and 1-12.

In process P1, a material may be deposited within a cavity of a mold. More specifically, a powder material may be deposited into the cavity of the mold that is defined, at least in part, by a first portion and a second portion engaging the first portion. The powder material may include any suitable thermoplastic material including, but not limited to, polyethylene (PE), polypropylene, and/or polyvinyl chloride (PVC). In a non-limiting example, depositing the material within the cavity of the mold may also include positioning a plurality of fibers within the second portion of the mold. The fibers may be positioned within the cavity of the mold prior to depositing the powder material in the cavity, or alternatively prior to depositing all of the predetermined amount of powder material in the cavity of the mold. The plurality of fibers may be positioned and/or oriented perpendicular to an inner surface of the second portion at least partially defining the cavity.

In process P2, a pressure may be applied to the material deposited within the cavity of the mold. The pressure may be applied to the material using the mold, and more specifically, the first portion and the second portion forming the mold. In a non-limiting example, applying the pressure may include compressing or applying a force to the first portion of the mold and/or the second portion of the mold. The first portion of the mold and the second portion of the mold may contact the material deposited in the cavity, and consequentially apply the pressure.

In process P3 the material deposited within the cavity of the mold may be heated. More specifically, the material deposited within the cavity may be heated to a predetermined temperature and/or for a predetermined period of time. Heating the powder material may include heating the first portion of the mold to a first predetermined temperature for a first predetermined period of time. In another non-limiting example, heating the powder material may also include heating the second portion of the mold to a second predetermined temperature for a second predetermined period of time. In the non-limiting example where heating includes heating by both the first portion and the second portion of the mold, the first predetermined temperature and the first predetermined period of time may differ or be distinct from the second predetermined temperature and the second predetermined period of time, respectively. For example, the first predetermined temperature may be greater than the second predetermined temperature, and/or the first predetermined period of time may be greater than the second predetermined period of time.

In process P4, the material may be cooled. More specifically, the powder material deposited within the cavity of the mold may be cooled after being heated to the predetermined temperature for the predetermined period of time. Once the material is heated to the predetermined temperature for the predetermined period of time, the application of the heat may be discontinued and/or stop. In one non-limiting example, the material may be cooled naturally within the mold, without the influence or inclusion of additional devices, systems, and/or cooling processes. In other non-limiting examples, the heated powder material may be rapidly cooled using cooling systems and/or cooling techniques. The heating and subsequent cooling of the powder material may form a thermoplastic component. That is, heating the powder material under constant pressure, and the subsequent cooling the material may result in the formation of a thermoplastic component having a shape, geometry, and/or configuration of the cavity of the mold.

In addition to forming the thermoplastic component, heating the powder material under constant pressure, and subsequently cooling the material, a crystallization gradient may be formed within the thermoplastic component. That is, performing processes P1-P4 may result in the formation of a crystallization gradient in the thermoplastic component. The thermoplastic component including the crystallization gradient may include a unitary body having a first section including a first exposed surface, and a second section include a second exposed surface, positioned opposite first exposed surface. In the non-limiting example, the first section may include or have a first crystallinity, and the second section may include or have a second crystallinity, which may differ from (e.g., be lower) the first crystallinity of the first section.

In process P5, a surface of the thermoplastic component may be undergoing a peening process. More specifically, and in response to cooling the thermoplastic component, a surface of the thermoplastic component may be laser peened to form a scalloped pattern thereon. In a non-limiting example, the first surface of the first section (including the first crystallinity) may be laser peened using a pulsed laser or energy beam. As a result of laser peening the thermoplastic component, the first surface may include a scalloped pattern thereon, where each scallop or dimple includes a predetermined depth or height.

Although discussed herein as thermoplastics and/or thermoplastic components, it is understood that the system and/or processes may be used to form components formed from a plurality of other material distinct from thermoplastics. For example, the system and/or processes discussed herein with respect to FIGS. 1-14 may be used to form components from metal material, thermosetting polymers, ceramic material, or any other suitable material.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A system for forming a component, comprising:
a mold including a first portion and a second portion engaging the first portion, at least one of the first portion or the second portion receiving material for the component;
a compressive device positioned adjacent to and contacting the first portion of the mold; and
a control system in communication with the compressive device, the control system configured to:
displace the compressive device to:
apply a compressive force to the first portion of the mold, and
impose a predetermined pressure on the material for the component; and
heat at least one of the first portion or the second portion of the mold.

2. The system of claim 1, further comprising a first heating device one of:
formed integrally within the compressive device,
formed integral within the first portion of the mold, or
distinct from and positioned between the compressive device and the first portion of the mold.

3. The system of claim 2, further comprising a support device positioned adjacent to and contacting the second portion of the mold.

4. The system of claim 3, further comprising a second heating device one of:
formed integrally within the support device,
distinct from and positioned adjacent the second portion of the mold, or
distinct from and positioned between the support device and the second portion of the mold.

5. The system of claim 4, wherein the control system is configured to heat the second portion of the mold via the second heating device.

6. The system of claim 3, wherein the control system is configured to heat at least one of:
the first portion of the mold via the compressive device, or
the second portion of the mold via the support device.

7. The system of claim 1, further comprising:
a laser configured to provide a pulsed energy beam on the component.

8. A component, the component comprising:
a body including:
a first section including a first surface of the body, the first section having a first material characteristic; and
a second section positioned opposite the first section, the second section including a second surface of the body,
wherein the second section has a second material characteristic that is distinct from the first material characteristic of the first section.

9. The component of claim 8, wherein the first material characteristic and the second material characteristic includes at least one of:
a crystallinity of the first section and the second section, respectively,
a tensile strength of the first section and the second section, respectively,
a hardness of the first section and the second section, respectively,
an impact strength of the first section and the second section, respectively, or
a ductility of the first section and the second section, respectively.

10. The component of claim 9, wherein the crystallinity of the first section is greater than the crystallinity of the second section.

11. The component of claim 9, wherein the crystallinity of the first section is within a range of approximately 70% to approximately 80%, and the crystallinity of the second section is within a range of approximately 50% to approximately 65%.

12. The component of claim 8, wherein the body further includes a third section positioned between the first section and the second section, the third section having a third material characteristic that is distinct from the first material characteristic of the first section and the second material characteristic of the second section.

13. The component of claim 8, wherein the first surface of the body includes a scalloped pattern.

14. The component of claim 13, wherein a depth of each scallop of the scalloped pattern formed on the first surface is within a range of approximately 1 millimeter (mm) to approximately 15 mm.

15. The component of claim 8, wherein the body further includes fibers positioned within at least a portion of at least one of the first section and the second section.

16. The component of claim 15, wherein the fibers extend within the body perpendicular to the first surface and the second surface of the body.

17. The component of claim 15, wherein the fibers include a plurality of rows of fibers, each of the plurality of rows of fibers extending within the body, parallel to one another.

18. The component of claim 15, wherein the fibers formed as a plurality of rows of the fibers, the plurality of rows of the fibers including:
a first row of the fibers extend within the body perpendicular to the first surface and the second surface, and extending within the body at a first orientation; and
a second row of the fibers extend within the body perpendicular to the first surface and the second surface, and extending within the body at a second orientation, the second orientation distinct from the first orientation.

19. A method of forming a component, the method comprising:
depositing a material within a cavity of a mold, the cavity formed between a first portion of the mold and a second portion engaging the first portion;
applying a pressure to the material deposited within the cavity of the mold;
heating the material deposited within the cavity of the mold to a predetermined temperature for a predetermined period of time; and
cooling the material deposited within the cavity of the mold to form the component.

20. The method of claim 19, wherein depositing the material within the cavity of the mold further includes positioning a plurality of fibers within the second portion of the mold prior to depositing the material in the second portion of the mold, the plurality of fibers positioned perpendicular to an inner surface of the second portion at least partially defining the cavity and receiving the deposited material.
